(19) United States
(12) Patent Application Publication
(10) Pub. No.: US 2026/0256060 A1
(43) Pub. Date: Sep. 3, 2026

(54) LOG BARK FLOWERPOT AND METHOD FOR MANUFACTURING SAME

(71) Applicants: Gwang Seok JEON, Yongin-si (KR); Woo Young JEON, Yongin-si (KR)

(72) Inventors: Gwang Seok JEON, Yongin-si (KR); Woo Young JEON, Yongin-si (KR)

(21) Appl. No.: 18/866,492

(22) PCT Filed: Jun. 23, 2023
(86) PCT No.: PCT/KR2023/008741

§ 371 Date: Nov. 15, 2024

(30) Foreign Application Priority Data
Jul. 15, 2022 (KR) 10-2022-0087646

(51) Int. Cl. A01G 9/02; B27M 1/08

(52) U.S. Cl. CPC A01G 9/02; B27M 1/08

(57) ABSTRACT

The technical objective of the present invention is to provide a log bark flowerpot which can make the impression of nature and improve processability so as to enable mass production. For this purpose, the log bark flowerpot according to the present invention comprises: a bark isolated from a xylem of a log and having a longitudinal cut portion; a circumference forming portion which forms a circumference portion including the bark and has a vertical through-hole shape; and a bottom forming portion which blocks the lower open portion of the circumference forming portion and forms a bottom portion.

### TECHNICAL FIELD

The present invention relates to a flowerpot.

### BACKGROUND ART

Generally, a flowerpot is a container which plants and grows plants such as flowers or trees. As such flowerpots, plastic flowerpots made from plastic injection molding and ceramic flowerpots made by baking soil are known.

These plastic or ceramic flowerpots have limitations in providing the impression of nature due to the cold and hard impression in the characteristics of the material.

As a conventional technique for solving these problems, Korean Utility Model Registration Publication No. 20-0427153 discloses a log flowerpot which is manufactured by preparing a log with a thick outer layer as a material, cutting the prepared log horizontally, leaving only 5 to 10 mm on the outer side of the log, and digging out the xylem in the inside thereof.

However, a conventional log flowerpot has a problem that it take a long time to manufacture because it provide a technical configuration that digs out the xylem with a machine, and especially in the case of oak trees with hard xylem, they cannot be manufactured in a few pieces, and the processing blade may be damaged, which results in a significant drop in productivity. Due to the nature of the flowerpot, which come constantly in contact with moisture, the wood easily rots, which causes a problem that durability is decreased. Consequently, mass production is impossible, and thus it is practically impossible to develop and distribute as a product.

### DETAILED DESCRIPTION OF THE INVENTION

### Technical Problem

It is an object of the present invention to provide a log bark flowerpot which can make the impression of nature and improve processability so as to enable mass production and a method for manufacturing the same.

It is an object of the present invention to provide a log bark flowerpot which can improve durability and a method for manufacturing the same.

### Technical Solution

In order to achieve the above object, a log bark flowerpot according to an embodiment of the present invention comprises: a bark isolated from a xylem of a log and having a longitudinal cut portion; a circumference forming portion which forms a circumference portion including the bark and has a vertical through-hole shape; and a bottom forming portion which blocks the lower open portion of the circumference forming portion and forms a bottom portion.

The bark may be isolated by boiling the xylem of the log or pretreating the xylem with an isolating agent.

In one example, the circumference forming portion may comprise: a circumference forming member formed of the bark and having the longitudinal cut portion adhered thereto; a pipe shaped circumference waterproofing member positioned inside the circumference forming member; a circumference fixing member that fixes the circumference forming member and the circumference waterproofing member to the bottom forming member so that the interval between the inner surface of the circumference forming member and the outer surface of the circumference waterproofing member is maintained at a set interval; and a circumference filler of water-resistant material filled between the inner surface of the circumference forming member and the outer surface of the circumference waterproofing member. Here, PET or PVC pipes may be used as the circumference waterproofing member, silicone may be used as the circumference fixing member in order to increase the sealing force between the circumference forming member, the circumference waterproofing member, and the bottom forming member, and transparent epoxy resin may be used as the circumference filler.

In another example, the circumference forming portion may comprise: a circumference forming member formed of the bark and having a circumferential length cut based on the longitudinal cut portion; a pipe shaped circumference waterproofing member wrapped by the circumference forming member and having an outer diameter corresponding to the inner diameter of the cut circumferential length; an adhesive that adheres the inner surface of the circumference forming member to the outer surface of the circumference waterproofing member; and a circumference fixing member that fixes the adhered circumference forming member and the circumference waterproofing member to the bottom forming member. Here, as the circumference fixing portion, silicon may be used in order to increase the sealing force between the circumference waterproofing member and the bottom forming member.

In yet another example, the circumference forming portion may comprise: a circumference forming member formed of the bark and having the longitudinal cut portion adhered thereto; a circumference fixing member that fixes the circumference forming member to the bottom forming member; and a circumference waterproofing agent of a water-resistant material applied to the inner surface of the circumference forming member. The circumference waterproofing agent may be applied to the inner surface of the circumference forming member at least once. A transparent epoxy resin may be used as the circumference waterproofing agent.

The bottom forming portion may comprise a plate-shaped bottom forming member that blocks the lower open portion of the circumference forming portion. Here, the bottom forming member may have a plate shape and may be made of a water-resistant material such as plastic. For example, PET (polyethylene terephthalate) may be used as the plastic.

The bottom forming portion may further comprise a bottom filler filled on the bottom forming member. Here, a transparent epoxy resin may be used as the bottom filler. The transparent epoxy resin used as the bottom filler may further contain a color toning agent.

The log bark flowerpot according to the above-mentioned embodiment of the present invention may further comprise a drainage hole formed by penetrating the bottom forming member and the bottom filler.

The log bark flowerpot according to the above-mentioned embodiment of the present invention may further comprise a bottom support member provided on the lower surface of the bottom forming member and supporting the bottom forming member in a state separated from the ground.

The bottom support member may be made of a rubber material or coated with a rubber material.

On the other hand, a method for manufacturing a log bark flowerpot according to an embodiment of the present invention comprises: a step of cutting a log to a set length; a strep of pre-treating a bark of the cut log so as to be smoothly isolated from a xylem; a step of cutting the bark of the pre-treated log longitudinally to separate from the xylem; a step of drying the separated bark; and a step of forming a circumference and a bottom using a circumference forming portion including the dried bark and a bottom forming portion including a bottom forming member.

In one example, the pre-treating step may comprise a step of preparing a container filled with water; a step of putting the cut log into the prepared container; and a step of heating the water for a set time. Here, the set time may be approximately 1 hour.

In another example, the pre-treating step may comprise a step of preparing a container filled with water; a step of putting an isolating agent into the prepared container; and a step of soaking the cut log in the container containing the isolating agent for a set time. Here, the set time can be approximately 2 days.

In one example, the step of forming a circumference and a bottom may comprise a step of adhering the cut portion of the dried bark to complete a circumference forming member; a step of positioning a pipe shaped circumference waterproofing member inside the circumference forming member in order to block water penetration into the inner surface of the circumference forming member; a step of fixing the circumference forming member and the circumference waterproofing member to the bottom forming member so that the interval between the inner surface of the circumference forming member and the outer surface of the circumference waterproofing member is maintained at a set interval; and a step of filling a circumference filler of water-resistant material between the inner surface of the circumference forming member and the outer surface of the circumference waterproofing member. Here, the set interval may be approximately 3 to 5 mm. The cut portion of the bark may be adhered with a wood adhesive. Silicone may be used to fix the circumference forming member and the circumference waterproofing member to the bottom forming member. In addition, the step of forming the circumference and the bottom may further comprise a step of filling the bottom filler on top of the bottom forming member after the step of filling with the circumference filler. Here, the bottom filler may be filled to a thickness of 15 to 20 mm.

In another example, the step of forming a circumference and a bottom may comprise a step for preparing a circumference waterproofing member in the shape of a pipe; a step for cutting the circumferential length of the dried bark so as to match the outer diameter of the circumference waterproofing member and preparing the cut bark as a circumference forming member; a step for wrapping and adhering the circumference waterproofing member with the cut circumference forming member; and a step for fixing the circumference forming member and the circumference waterproofing member to a bottom forming member. Here, silicone may be used to fix the circumference forming member and the circumference waterproofing member to the bottom forming member. In addition, the step of forming a circumference and a bottom may further comprise a step of filling a bottom filler on top of the bottom forming member after the step of fixing the bottom forming member. Here, the bottom filler may be filled to a thickness of 15 to 20 mm.

In yet another example, the step of forming a circumference and a bottom may comprise a step of adhering the cut portion of the dried bark to complete a circumference forming member; a step of fixing a bottom forming member to the lower surface of the circumference forming member; and a step of applying a waterproofing agent of water-resistant material to the inner surface of the circumference forming member to block water penetration into the inner surface of the circumference forming member. Here, silicone may be used to fix the bottom forming member to the lower surface of the circumference forming member. The circumference waterproofing agent may be applied 2 to 3 times. In addition, the step of forming a circumference and a bottom may further comprise a step of filling a bottom filler on the bottom forming member before or after the step of applying the circumference waterproofing agent. Here, the bottom filler may be filled to a thickness of 15 to 20 mm.

A method for manufacturing the log bark flowerpot according to an embodiment of the present invention described above may further comprise a step of forming a drainage hole by penetrating the bottom forming member and the bottom filler after the step of forming the circumference and the bottom.

A method for manufacturing the log bark flowerpot according to an embodiment of the present invention described above may further include a step of providing a bottom support member on the lower surface of the bottom forming member after the step of forming the circumference and the bottom, and supporting the bottom forming member in a state separated from the ground.

### Advantageous Effects

As mentioned above, a log bark flowerpot and a method for manufacturing the same according to an embodiment of the present invention can have the following effects.

According to an embodiment of the present invention, a technical configuration is provided in which a log bark flowerpot includes a bark, a circumference forming portion and a bottom forming portion, the bark is isolated from the xylem of the log and has a longitudinal cut portion, and the circumference forming portion forms the circumference including the bark and has a vertical through-hole shape. Therefore, the log bark flowerpot of the present invention can achieve an intrinsic appearance of nature through the bark of the log, so it can convey the impression of nature as it is. Further, unlike a conventional technology of making a flowerpot by painstakingly digging out the hard xylem of a log, the bark of the log can be easily separated by isolating it from the xylem, thereby dramatically improving productivity and enabling mass production of the log bark flowerpot of the present invention.

In addition, according to an embodiment of the present invention, a technical configuration is provided in which the bark is isolated by boiling the xylem of the log or pre-treating it with an isolating agent, and therefore, without using a separate physical tool such as a saw or knife, the bark of the log can be more easily isolated from the xylem through this pre-treatment, and ultimately, it can further contribute to the mass production of the log bark flowerpot of the present invention.

Furthermore, according to an embodiment of the present invention, since a technical configuration is provided in which the circumference forming portion includes a circumference forming member made of a bark and a circumference waterproofing member or a circumference waterproofing agent for waterproofing the same, it is possible to prevent the circumference forming member made of the bark of the log from rotting or becoming moldy due to the water given to the log bark flowerpot of the present invention, and ultimately improve durability from moisture, so that the log bark flowerpot of the present invention can be used semi-permanently.

Furthermore, according to an embodiment of the present invention, since a technical configuration further comprising a bottom filler is provided, the thickness of the bottom portion of the log bark flowerpot of the present invention can be reinforced together with the bottom forming member, and the waterproof performance can be improved.

Furthermore, according to an embodiment of the present invention, since a technical configuration comprising a bottom support member is provided, the bottom forming member can be supported in a state separated from the ground, and thus the drainage hole is not blocked by the table and the drained water can be smoothly drained to the outside, so that the ventilation performance is improved, which can prevent the occurrence of mold in the log bark flowerpot of the present invention and prevent deformation of the circumference forming member made of the log bark.

On the other hand, according to an embodiment of the present invention, a technical configuration is provided in which a method for manufacturing the log bark flowerpot comprises a step of cutting a log to a set length, a step of pre-treating a bark of the cut log so as to be smoothly isolated from a xylem, a step of cutting the bark of the pre-treated log longitudinally to separate from the xylem, a step of drying the separated bark, and a step of forming a circumference and a bottom using a circumference forming portion including the dried bark and a bottom forming portion including a bottom forming member. Therefore, the log bark flowerpot of the present invention can achieve an intrinsic appearance of nature through the bark of the log, so it can convey the impression of nature as it is. Thus, unlike a conventional technology of making a flowerpot by painstakingly digging out the hard xylem of a log, the bark of the log can be easily separated by isolating it from the xylem, thereby dramatically improving productivity and enabling mass production of the log bark flowerpot of the present invention.

### BRIEF DESCRIPTION OF THE DRAWINGS

FIG. 1 is a cross-sectional view which schematically shows a log bark flowerpot according to a first embodiment of the present invention.

FIG. 2 is a diagram which schematically shows the process of making the log bark flowerpot of FIG. 1.

FIG. 3 is a diagram which schematically shows the log bark flowerpot of FIG. 1.

FIG. 4 is a diagram which schematically shows a state in which plants are planted in the log bark flowerpot of FIG. 3.

FIG. 5 is a diagram which schematically shows a method for manufacturing the log bark flowerpot of FIG. 1.

FIG. 6 is a diagram which schematically shows a log bark flowerpot according to a second embodiment of the present invention.

FIG. 7 is a photograph showing the log bark flowerpot of FIG. 6.

FIG. 8 is a diagram which schematically shows a state in which plants are planted in the log bark flowerpot of FIG. 7.

FIG. 9 is a flowchart which schematically shows a method for manufacturing a log bark flowerpot of FIG. 6.

FIG. 10 is a cross-sectional view which schematically shows a log bark flowerpot according to a third embodiment of the present invention.

FIG. 11 is a flowchart which schematically shows a method for manufacturing a log bark flowerpot of FIG. 10.

### DETAILED DESCRIPTION OF THE EMBODIMENTS

Hereinafter, with reference to the accompanying drawings, various embodiments of the present invention will be described in detail to the extent that one of ordinary skill in the art can easily practice the present invention. The present invention may be implemented in various different forms, and is not limited to the embodiments described herein.

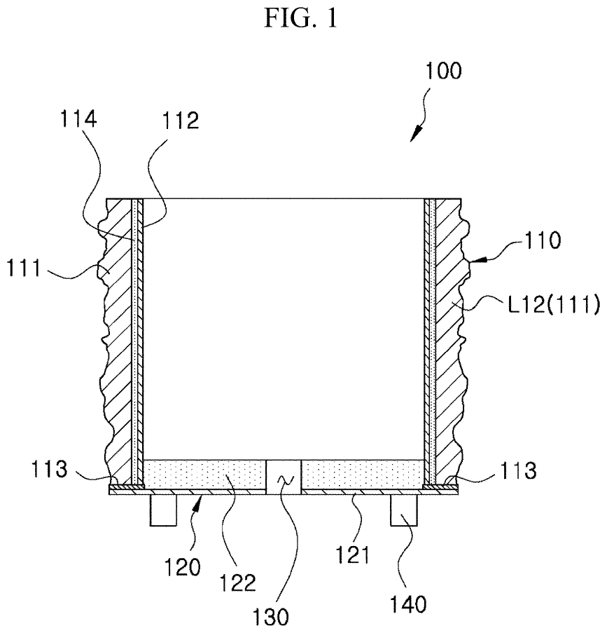

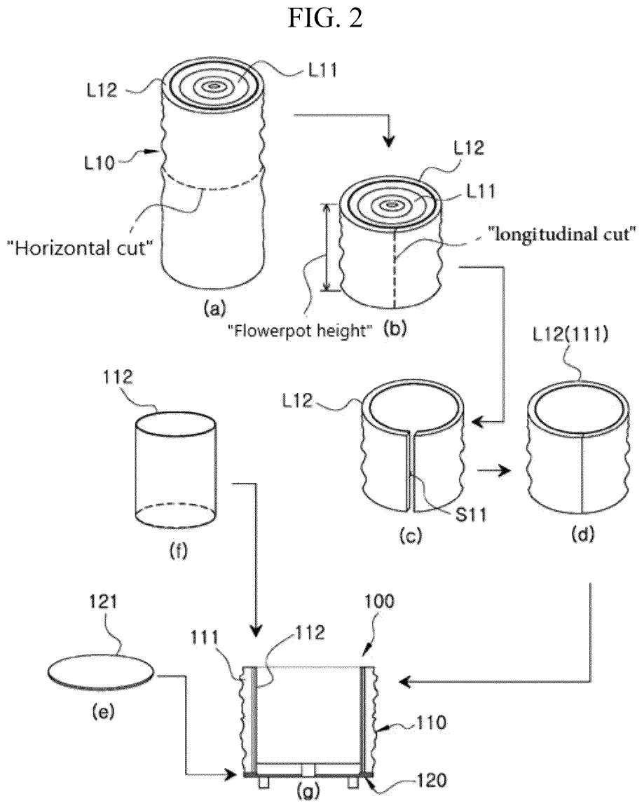

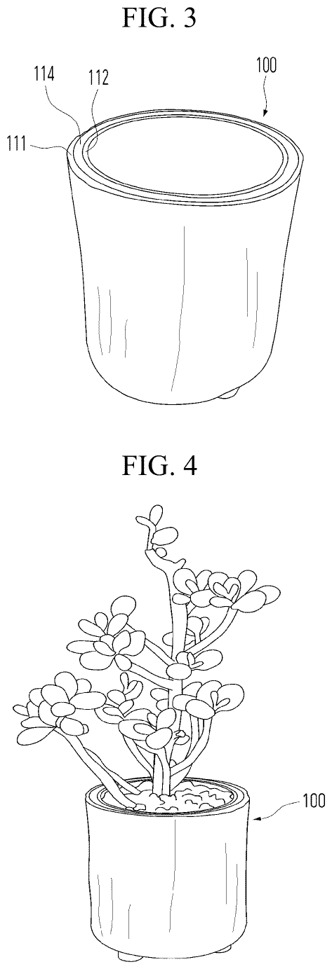

FIG. 1 is a cross-sectional view which schematically shows a log bark flowerpot according to a first embodiment of the present invention. FIG. 2 is a diagram which schematically shows the process of making the log bark flowerpot of FIG. 1. FIG. 3 is a diagram which schematically shows the log bark flowerpot of FIG. 1. FIG. 4 is a diagram which schematically shows a state in which plants are planted in the log bark flowerpot of FIG. 3.

The log bark flowerpot 100 according to a first embodiment of the present invention includes a bark L12, a circumference forming portion 110, and a bottom forming portion 120, as illustrated in FIGS. 1 to 4. Each component will be described in detail below with reference to FIGS. 1 to 4.

The bark L12 is one of the components for constituting the circumference forming portion 110, as illustrated in FIG. 1 and FIG. 2. Such a bark L12 is isolated from the xylem L11 of the log L10, as illustrated in FIG. 2, and may have a longitudinal cut portion S11. For example, in order to obtain the bark L12, the log L10 can be cut to a set length (see a in FIG. 2), and the bark L12 of the cut log L10 can be cut vertically (see b in FIG. 2) and isolated from the xylem L11. Furthermore, this bark L12 may be provided in a dried state.

The circumference forming portion 110 is a component for forming the circumference portion of the log bark flowerpot 100 of the present invention, as illustrated in FIGS. 1 and 2. Such a circumference forming portion 110 may be formed to include a bark L12 isolated from the xylem L11 of the log L10, as illustrated in FIG. 2, and may have a shape that penetrates in the vertical direction (see d of FIG. 2).

The bottom forming portion 120 is a component for forming the bottom portion of the log bark flowerpot 100 of the present invention, as illustrated in FIG. 1. Such a bottom forming portion 120 may be provided to block the lower open portion of the circumference forming portion 110. For example, the bottom forming portion 120 may include a plate-shaped bottom forming member 121 that blocks the lower open portion of the circumference forming portion 110. Furthermore, the bottom forming member 121 may be made of a water-resistant material such as plastic. For reference, the bottom forming member 121 is a component that faces an upper surface of a table when the log bark flowerpot 100 of the present invention is placed on a table, etc., whereby the degree of external exposure is considerably smaller than the bark L12 of the circumference forming portion 110 and thus, instead of the log, plastic with excellent waterproofing performance may be more advantageous. In addition, the bottom forming member 121 can be made of a transparent material, and can be made of PET (polyethylene terephthalate), which is one type of plastic.

Therefore, since such components are provided, the log bark flowerpot 100 of the present invention can achieve an intrinsic appearance of nature through the bark L12 of the log L10, so it can convey the impression of nature as it is. Further, unlike a conventional technology of making a flowerpot by painstakingly digging out the hard xylem of a log, the bark L12 of the log L10 can be easily separated by isolating it from the xylem L11, thereby dramatically improving productivity and enabling mass production of the log bark flowerpot 100 of the present invention.

Furthermore, the bark L12 forming the exterior of the circumference forming portion 110 may be isolated from the xylem L11 of the log L10 by pretreatment, that is, boiling or by using a peeling agent (containing sodium hydroxide). Therefore, without using a separate physical tool such as a saw or knife for isolation, the bark L12 of the log L10 can be isolated more easily from the xylem L11 through this pretreatment, and ultimately, it can further contribute to the mass production of the log bark flowerpot 100 of the present invention.

Next, the circumference forming portion 110 will be described in more detail with reference to FIGS. 1 to 4.

The circumference forming portion 110 may have a structure that blocks water from penetrating into the circumference forming member 111 formed of a bark L12. Specifically, the circumference forming portion 110 may include a circumference forming member 111, a circumference waterproofing member 112, a circumference fixing member 113, and a circumference filler 114, as illustrated in FIGS. 1 and 2. The circumference forming member 111 may be formed of a bark L12, and a longitudinal cut portion S11 of the bark L12 may be in a state adhered with a wood adhesive. The circumference waterproofing member 112 may have a pipe shape, and may be positioned inside the circumference forming member 111. The circumference fixing member 113 can fix the circumference forming member 111 and the circumference waterproofing member 112 to the bottom forming member 121 so that the inner surface of the circumference forming member 111 and the outer surface of the circumference waterproofing member 112 are maintained at a set interval. The circumference filler 114 can be made of a water-resistant material, and can be filled between the inner surface of the circumference forming member 111 and the outer surface of the circumference waterproofing member 112. Here, PET or the like can be used as the circumference waterproofing member 112, and silicone or the like can be used as the circumference fixing member 113 in order to increase a sealing force between the circumference forming member 111 and the circumference waterproofing member 112 and the bottom forming member 121. A transparent epoxy resin can be used as the circumference filler 114.

Therefore, even if water is given to a plant in the log bark flowerpot 100 of the present invention, the water going to the circumference forming member 111 can be blocked by the circumference waterproofing member 112 and the circumference filler 114, so that the circumference forming member 111 made of the bark L12 of the log L10 can be prevented from rotting or becoming moldy, and ultimately, the durability against moisture is improved, so that the log bark flowerpot 100 of the present invention can be used semi-permanently.

In addition, the log bark flowerpot 100 according to a first embodiment of the present invention may further include a bottom filler 122 as illustrated in FIGS. 1 and 2. The bottom filler 122 may be filled on the bottom forming member 121. Here, the bottom filler 122 may be filled to a thickness of approximately 15 to 20 mm. Therefore, the thickness of the bottom portion of the log bark flowerpot 100 of the present invention can be reinforced together with the bottom forming member 121, and the waterproof performance can be improved.

Also, a transparent epoxy resin may be used as the bottom filler 122. Furthermore, the transparent epoxy resin used as the bottom filler 122 may further contain a color toning agent (not shown) for a bottom pattern.

In addition, the log bark flowerpot 100 according to a first embodiment of the present invention may further include a drainage hole 130 as illustrated in FIGS. 1 and 2. The drainage hole 130 may be formed in a form penetrating the bottom forming member 121 and the bottom filler 122.

In addition, the log bark flowerpot 100 according to a first embodiment of the present invention may further include a bottom support member 140 as illustrated in FIGS. 1 and 2. The bottom support member 140 may be provided on the lower surface (i.e., the bottom surface) of the bottom forming member 121, and may support the bottom forming member 121 in a state separated from the ground. Therefore, the drainage hole 130 is not blocked by the table, so that the water can be drained smoothly to the outside. For example, the bottom support member 140 may be made of a rubber material or coated with a rubber material.

Next, a method for manufacturing a log bark flowerpot 100 according to a first embodiment of the present invention will be described with reference to FIGS. 1 to 5.

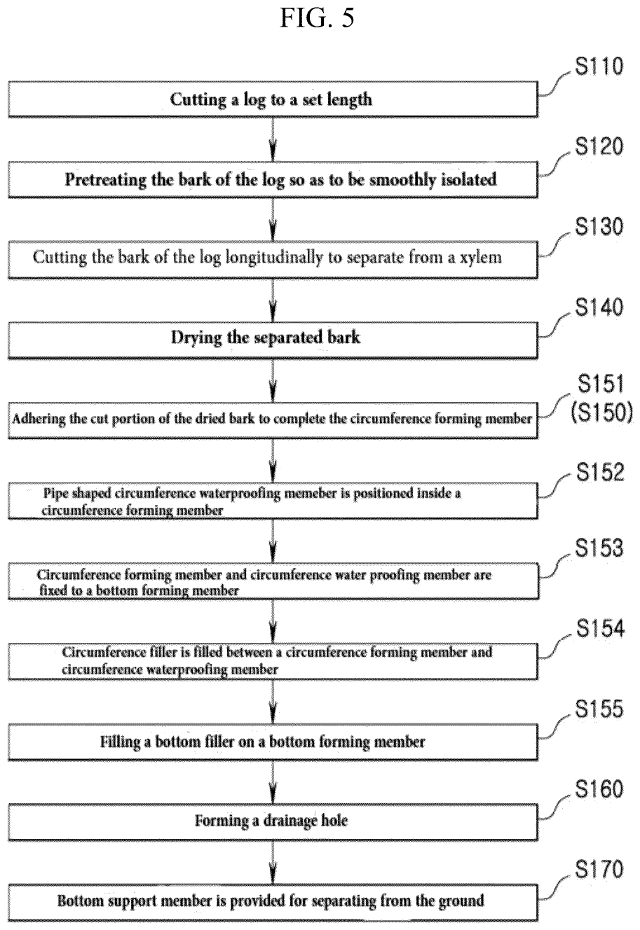

FIG. 5 is a diagram which schematically shows a method for manufacturing the log bark flowerpot of FIG. 1.

The method for manufacturing a log bark flowerpot 100 according to a first embodiment of the present invention first cuts a log L10 to a set length (see a in FIG. 2, and S110 in FIG. 5). For reference, the set length may be the height of the log bark flowerpot 100 of the present invention.

Then, the bark L12 of the cut log is smoothly isolated from the xylem L11 (S120). In one example, although the pretreatment process S120 is not illustrated, it may be performed by a series of processes (not illustrated) in which a container filled with water (not shown) is prepared, the cut log is put in the prepared container, and water is heated for a set time. Here, the heating set (boiling) time may be approximately 1 hour. In another example, although the pretreatment process is not illustrated, it may be performed by a series of processes in which a container filled with water is prepared, an isolating agent containing sodium hydroxide is put in the prepared container, and the cut log is soaked in the container containing the isolating agent for a set time. Here, the soaking set time may be approximately 2 days.

Subsequently, the bark L12 of the pretreated log is cut vertically to separate it from the xylem L11 (see b and c of FIG. 2, and S130 of FIG. 5). Then, the separated bark L12 is dried in the shade S140. Then, the circumference and the bottom of the log bark flowerpot 100 of the present invention are formed using the circumference forming portion 110 including the dried bark L12 and the bottom forming portion 120 including the bottom forming member 121 (see d, e, f and g of FIG. 2, and S150 of FIG. 5). Specifically, the process of forming the circumference and the bottom (see S150 of FIG. 5) is as follows.

First, the cut portion S11 of the dried bark L12 can be adhered to complete the circumference forming member 111 (see d in FIG. 2, and S151 in FIG. 5). Next, a pipe shaped circumference waterproofing member 112 can be positioned inside the circumferential forming member 111 in order to block water penetration into the inner surface of the circumference forming member 111 (S152 in FIG. 5). Then, the set of the circumference forming member 111 and the circumference waterproofing member 112 can be fixed to the bottom forming member 121 by a circumference fixing member 113 so that the interval between the inner surface of the circumference forming member 111 and the outer surface of the circumference waterproofing member 112 is maintained at a set interval (S153 in FIG. 5). Finally, a circumference filler 114 made of water-resistant material can be filled between the inner surface of the circumference forming member 111 and the outer surface of the circumference waterproofing member 112 (S154 in FIG. 5).

Here, in the process of completing the circumference forming member 111 (S151 of FIG. 5), the cut portion S11 of the bark L12 can be adhered with a wood adhesive. And, in the process of fixing the bottom forming member 121 with the circumference fixing member 113 (S153 of FIG. 5), the bottom forming member 121 can have a plate shape and can be made of a water-resistant material such as plastic, and PET (polyethylene terephthalate) material can be used as the plastic. And as the circumference fixing member 113, silicone can be used in order to increase a sealing force between the circumference forming member 111 and the circumference waterproofing member 112 and the bottom forming member 121. The setting interval of the circumference forming member 111 and the circumference waterproofing member 112 can be approximately 3 to 5 mm, and PET can be used as the circumference waterproofing member 112, and a transparent epoxy resin can be used as the circumference filler 114. In addition, the process of forming the circumference and the bottom (S150 of FIG. 5) may further include a process of filling the top of the bottom forming member 121 with a bottom filler 122 (S155 of FIG. 5) after the process of filling the circumference filler (S154 of FIG. 5) as described above is completed. Here, the bottom filler 122 may be filled to a thickness of 15 to 20 mm.

Subsequently, the bottom filler 122 is filled, and then can penetrate the bottom forming member 121 and the bottom filler 122 to form a drainage hole 130 (S160). Finally, a bottom support member 140 is provided on the lower surface of the bottom forming member 121 to support the bottom forming member 121 in a state separated from the ground (S170).

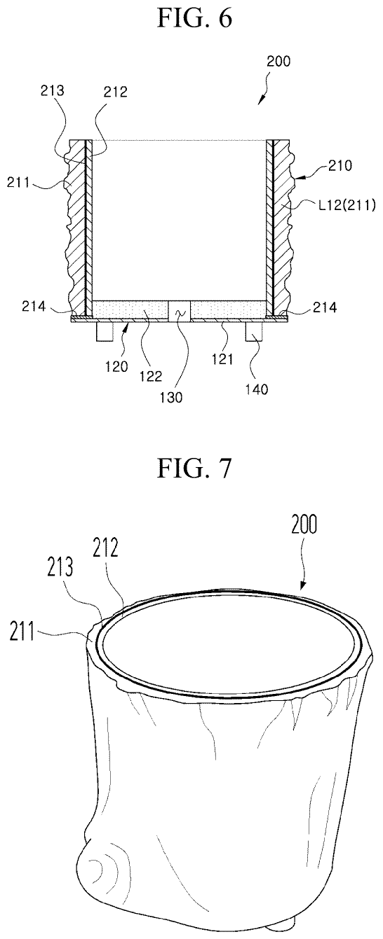

A log bark flowerpot 200 according to a second embodiment of the present invention will be described with reference to FIGS. 6 to 8.

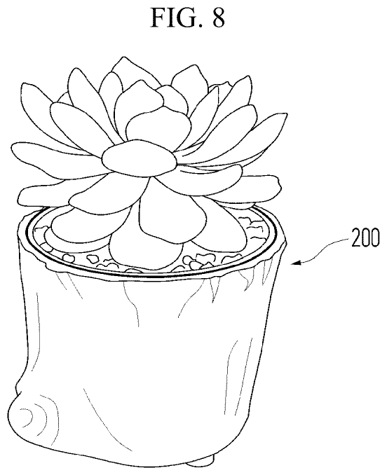

FIG. 6 is a diagram which schematically shows a log bark flowerpot according to a second embodiment of the present invention. FIG. 7 is a photograph showing the log bark flowerpot of FIG. 6. FIG. 8 is a diagram which schematically shows a state in which plants are planted in the log bark flowerpot of FIG. 7.

The log bark flowerpot 200 according to the second embodiment of the present invention is identical to the first embodiment of the present invention except for the circumference forming portion 210 as illustrated in FIG. 6, and therefore, the contents concerning this are mainly described.

The circumference forming portion 210 may include a circumference forming member 211, a circumference waterproofing member 212, an adhesive 213, and a circumference fixing member 214, as illustrated in FIG. 6. The circumference forming member 211 is formed from a bark L12, and its circumferential length may be cut on the basis of a longitudinal cut portion (see S11 of FIG. 2), and the cut portion may be provided in an open state without adhering with a wood adhesive. The circumference waterproofing member 212 may have a pipe shape and may be wrapped by the circumference forming member 211 in an opened state. The adhesive 213 may adhere the inner surface of the circumference forming member 211 to the outer surface of the circumference waterproofing member 212. The circumference fixing member 214 can fix a set of a circumference forming member 211 and a circumference waterproofing member 212, which are adhered to each other, to the bottom forming member 121.

Here, the circumferential forming member 211 can be cut to have an inner diameter corresponding to the outer diameter of the circumference waterproofing member 212 on the basis of the outer diameter thereof. A PVC pipe that is harder than PET can be used as the circumference waterproofing member 212, and silicon or the like can be used as the circumference fixing member 214 in order to increase the sealing force between the circumference waterproofing member 212 and the bottom forming member 121.

Next, a method for manufacturing a log bark flowerpot 200 according to the second embodiment of the present invention will be described with reference to FIGS. 6 to 9.

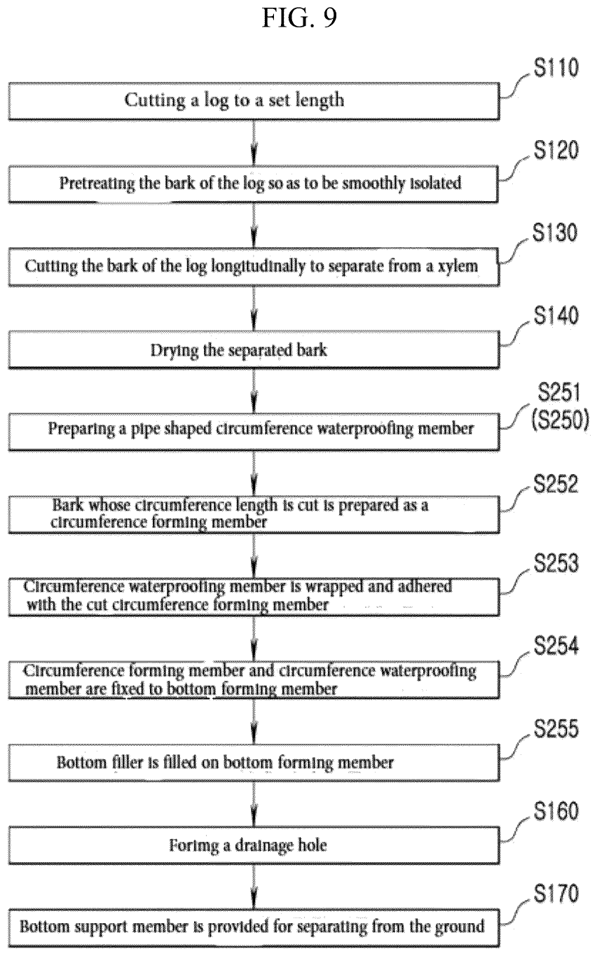

FIG. 9 is a flowchart which schematically shows a method for manufacturing a log bark flowerpot of FIG. 6.

The method for manufacturing the log bark flowerpot 200 according to the second embodiment of the present invention is identical to the manufacturing method mentioned in the first embodiment of the present invention, except for the process of forming the circumference and the bottom (S250), as illustrated in FIG. 9, and therefore, the contents concerning this are mainly described.

First, as illustrated in FIG. 9, a pipe-shaped circumference waterproofing member 212 is prepared (S251). Then, the circumference length of the dried bark (see L12 of FIG. 2) is cut to match the outer diameter of the circumference waterproofing member 212, and the cut bark L12 is prepared as a circumference forming member 211 (S252). Then, the circumference waterproofing member 212 is wrapped and adhered with the cut circumference forming member 211 (S253). Finally, the set of the circumference forming member 211 and the circumference waterproofing member 212 adhered to each other with an adhesive 213 is fixed to the bottom forming member 121 with a circumference fixing member 214 (S254).

Here, in the process of fixing with the circumference fixing member 214 (S254), as the circumference fixing member 214, silicone or the like may be used in order to seal and fix the set of the circumference forming member 211 and the circumference waterproofing member 212, which are adhered to each other, to the bottom forming member 121. The bottom forming member 121 may have a plate shape and may be made of a water-resistant material such as plastic, and PET (polyethylene terephthalate) may be used as the plastic.

In addition, the process of forming the circumference and the bottom (S250 of FIG. 9) may further include a process of filling the top of the bottom forming member 121 with a bottom filler 122 (S255 of FIG. 9) after the process of fixing with the circumference fixing member 214 as above (S254 of FIG. 9) is completed. Here, the bottom filler 122 may be filled to a thickness of 15 to 20 mm.

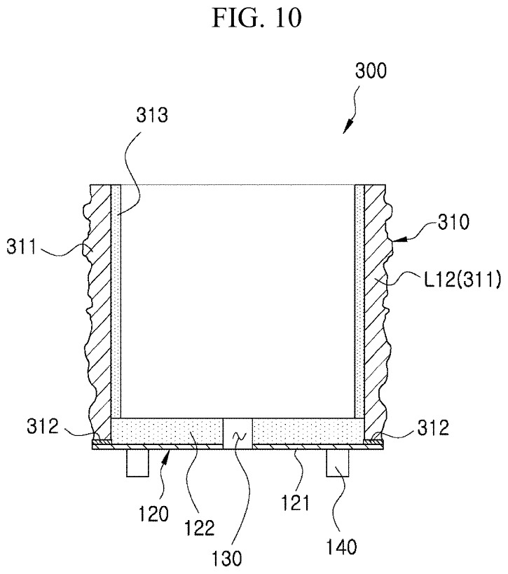

Next, a log bark flowerpot 300 according to the third embodiment of the present invention will be described with reference to FIG. 10.

FIG. 10 is a cross-sectional view which schematically shows a log bark flowerpot according to a third embodiment of the present invention.

The log bark flowerpot 300 according to the third embodiment of the present invention is identical to the first embodiment of the present invention described above except for the circumference forming portion 310 as illustrated in FIG. 10, and therefore, the contents concerning this are mainly described.

The circumference forming portion 310 may include a circumference forming member 311, a circumference fixing member 312, and a circumference waterproofing agent 313, as illustrated in FIG. 10. The circumference forming member 311 may be formed of a bark L12, and may have a longitudinal cut portion (see S11 of FIG. 2) of the bark L12 adhered with a wood adhesive. The circumference fixing member 312 may fix the circumference forming member 311 to the floor forming member 121. The circumference waterproofing agent 313 may be formed of a water-resistant material and may be applied to the inner surface of the circumference forming member 311.

Here, silicone or the like can be used as the circumference fixing member 312 in order to increase a sealing force between the circumference forming member 311 and the bottom forming member 121. The circumference waterproofing agent 313 can be applied to the inner surface of the circumference forming member 311 at least once. The circumference waterproofing agent 313 used herein can be a transparent epoxy resin.

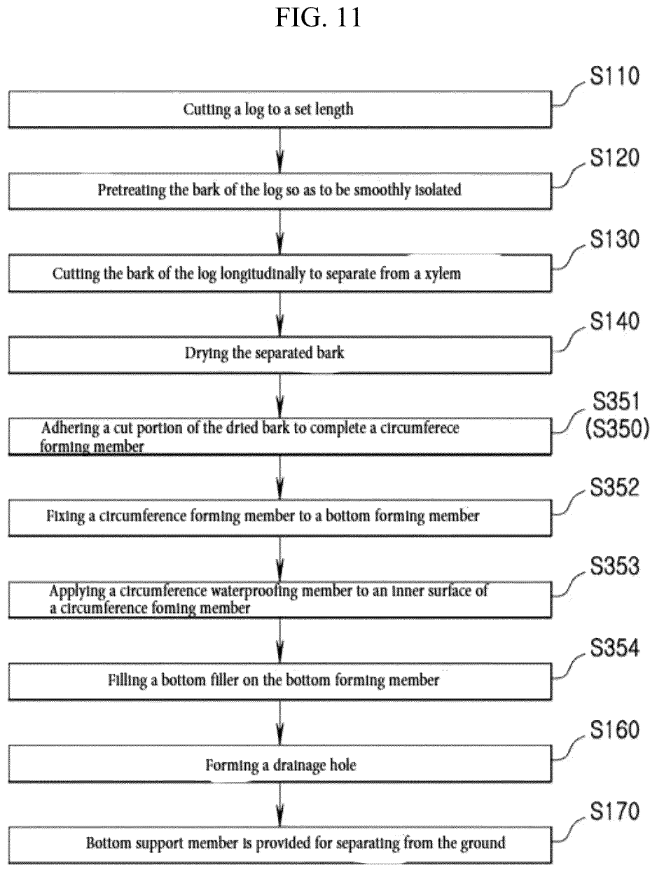

Next, a method for manufacturing a log bark flowerpot 300 according to the third embodiment of the present invention will be described with reference to FIGS. 10 and 11. FIG. 11 is a flowchart which schematically shows a method for manufacturing a log bark flowerpot of FIG. 10.

The method for manufacturing the log bark flowerpot 300 according to the third embodiment of the present invention is identical to the manufacturing method mentioned in the first embodiment of the present invention, except for the process of forming the circumference and the bottom (S350), as illustrated in FIG. 11, and therefore, the contents concerning this are mainly described.

First, as illustrated in FIG. 11, the cut portion (see S11 of FIG. 2) of the dried bark L12 can be adhered to complete the circumference forming member 311 (S351). Then, the circumference forming member 311 can be fixed to the bottom forming member 121 with the circumference fixing member 312 (S352). Finally, a waterproofing agent 313 made of water-resistant material can be applied to the inner surface of the circumference forming member 311 to block water penetration into the inner surface of the circumference forming member 311 (S353).

Here, the bottom forming member 121 may have a plate shape and may be made of a water-resistant material such as plastic, and PET (polyethylene terephthalate) may be used as the plastic. As the circumference fixing member 312, silicone, etc. may be used in order to increase the sealing force between the circumference forming member 311 and the bottom forming member 121. The circumference waterproofing agent 313 may be applied 2 to 3 times.

In addition, the process of forming the circumference and the bottom (S350 of FIG. 11) may further include a process of filling the top of the bottom forming member 121 with a bottom filler 122 (S354 of FIG. 11) after the process of applying the circumference waterproofing agent 313 (S353 of FIG. 11) is completed. Here, the bottom filler 122 may be filled to a thickness of 15 to 20 mm.

Although the present invention has been described and illustrated with specific preferred embodiments above, it will be obvious that the present invention is not limited to the embodiments set forth above, and various modifications and imitations can be made to the embodiments by those skilled in the art without departing from the spirit and scope of the present invention.

### Industrial Applicability

The present invention relates to a flowerpot and has industrial applicability.

1. A log bark flowerpot, comprising:
a bark isolated from a xylem of a log and having a longitudinal cut portion;
a circumference forming portion which forms a circumference portion including the bark and has a vertical through-hole shape; and
a bottom forming portion which blocks the lower open portion of the circumference forming portion and forms a bottom portion.

2. The log bark flowerpot of claim 1, wherein the log bark flowerpot has a waterproof structure that blocks water from penetrating into the circumference forming member

3. A method for manufacturing the log bark flowerpot of claim 1, the method comprising the steps of:
cutting a log to a set length;
pre-treating a bark of the cut log so as to be smoothly isolated from a xylem;
cutting the bark of the pre-treated log longitudinally to separate from the xylem;
drying the separated bark; and
forming a circumference and a bottom using a circumference forming portion including the dried bark and a bottom forming portion including a bottom forming member.
